(19) United States
(12) Patent Application Publication
(10) Pub. No.: US 2025/0303993 A1
(43) Pub. Date: Oct. 2, 2025

(54) FRONT STRUCTURE OF VEHICLE

(71) Applicant: TOYODA GOSEI CO., LTD., Kiyosu-shi (JP)

(72) Inventors: Takaki ITATSU, Aichi (JP); Koichi SUZUKI, Aichi (JP); Tomohiro KAJITANI, Aichi (JP); Masashi OTOYO, Aichi (JP); Hiroshi TAKAKURA, Aichi (JP)

(21) Appl. No.: 19/095,641

(22) Filed: Mar. 31, 2025

(30) Foreign Application Priority Data
Apr. 2, 2024 (JP) 2024-059547

(51) Int. Cl. B60R 19/34

(52) U.S. Cl. CPC B60R 19/34

(57) ABSTRACT

A front structure of a vehicle includes: a support member located between a pair of crash boxes; and a bumper reinforcement located in front of the pair of crash boxes and extending in the vehicle width direction, when a front and rear in the front-rear direction of the vehicle are defined as the front and rear. The support member includes: a body portion located between the pair of crash boxes; an attachment portion attached to the bumper reinforcement; a fixing portion extending from the body portion and fixed to the vehicle body frame; and a pair of extension portions extending from the body portion toward the front of the opening of the pair of crash boxes respectively. Each of the pair of extension portions has a fitting portion protruding rearward and fitted into the opening.

### CROSS-REFERENCE TO RELATED APPLICATIONS

This application is based on and claims priority under 35 USC 119 from Japanese Patent Application No. 2024-59547 filed on Apr. 2, 2024, the entire content of which is incorporated herein by reference.

### TECHNICAL FIELD

The present disclosure relates to a front structure of a vehicle.

### BACKGROUND ART

JP2019-137089A describes a front structure of a vehicle. The front structure of a vehicle described in JP2019-137089A includes a pair of front side members located on both sides in a vehicle width direction, and a pair of crash boxes coupled to respective front ends of the pair of front side members. The above-described front structure of the vehicle further includes a radiator support that supports a radiator between the pair of crash boxes, and a bumper reinforcement that is located in front of the radiator support and the crash boxes and extends in a vehicle width direction.

Front ends of the pair of crash boxes are joined to the bumper reinforcement. The radiator support includes a radiator support upper made of a resin in which an upper main body and a pair of side portions are integrally molded. The pair of side portions are respectively attached to the pair of crash boxes by a fastening member. The upper main body and the bumper reinforcement are coupled via a pair of braces.

### SUMMARY OF INVENTION

It may take time and effort to join the front ends of the crash boxes to the bumper reinforcement with the front structure of a vehicle described in JP2019-137089A. When the joining between the front ends of the crash boxes and the bumper reinforcement is omitted, relative displacement between the bumper reinforcement and the crash boxes is allowed. Therefore, a collision load applied to the bumper reinforcement may not be appropriately transmitted to the crash boxes.

Aspects of a front structure of a vehicle for addressing the above-described issues will be described.

(1) A front structure of a vehicle to be applied to a vehicle structure and to be assembled to the vehicle structure, the vehicle structure including a pair of vehicle body frames disposed at an interval in a vehicle width direction and a pair of crash boxes located in front of the pair of vehicle body frames in a front-rear direction of the vehicle and attached to the pair of vehicle body frames respectively, the pair of crash boxes having an opening being formed at a front end of the pair of crash boxes, the front structure including:
a support member located between the pair of crash boxes; and
a bumper reinforcement located in front of the pair of crash boxes and extending in the vehicle width direction, when a front and rear in the front-rear direction of the vehicle are defined as the front and rear, in which
the support member includes:
   a body portion located between the pair of crash boxes;
   an attachment portion attached to the bumper reinforcement;
   a fixing portion extending from the body portion and fixed to the vehicle body frame; and
   a pair of extension portions extending from the body portion toward the front of the opening of the pair of crash boxes respectively, and
each of the pair of extension portions has a fitting portion protruding rearward and fitted into the opening.

According to the above-described configuration, the front structure including the support member and the bumper reinforcement is formed by attaching the attachment portion of the support member to the bumper reinforcement. When the front structure is attached to the vehicle structure, the fitting portions of the pair of extension portions of the support member are respectively fitted to the openings of the pair of crash boxes. The front structure is fixed to the vehicle structure by fixing the fixing portion of the support member to the vehicle body frame. Accordingly, relative displacement of the support member with respect to the pair of crash boxes, that is, relative displacement of the bumper reinforcement is restricted.

As described above, according to the above-described configuration, the joining between the front end of the crash box and the bumper reinforcement may be omitted, and a collision load applied to the bumper reinforcement may be appropriately transmitted to the crash box.

(2) The front structure of a vehicle according to (1), in which
a plurality of openings are formed at the front end of the pair of crash box, and
the pair of extension portions include a plurality of fitting portions fitted to the plurality of openings respectively.

According to the above-described configuration, relative movement between the crash box and the bumper reinforcement is restricted at a plurality of locations at the front end of the crash box. Accordingly, the collision load applied to the bumper reinforcement may be more appropriately transmitted to the crash box.

(3) The front structure of a vehicle according to (1), in which
the extension portion includes a flat portion sandwiched between an edge portion of the opening and the bumper reinforcement.

According to the above-described configuration, a rear surface of the bumper reinforcement and the flat portion of the extension portion are in surface contact with each other, and the edge portion of the opening of the crash box and the flat portion of the extension portion are in surface contact with each other. Accordingly, the collision load applied to the bumper reinforcement may be more appropriately transmitted to the crash box.

(4) The front structure of a vehicle according to (3), in which
the flat portion is provided over an entire periphery of the opening.

According to the above-described configuration, when the collision load is applied to the bumper reinforcement, the entire edge portion of the opening is pressed by the flat portion. Therefore, the collision load transmitted from the bumper reinforcement may be prevented from being biased depending on a position of the front end of the crash box. Therefore, the collision load applied to the bumper reinforcement may be more appropriately transmitted to the crash box.

(5) The front structure of a vehicle according to (3) or (4), in which
the extension portion includes a protruding portion protruding forward or rearward on a base end side of the extension portion with respect to the fitting portions.

When the collision load acts on the extension portion via the bumper reinforcement, stress tends to concentrate on a portion of the extension portion on a base end side.

In this regard, according to the above-described configuration, since the portion of the extension portion on the base end side has the protruding portion, the rigidity of the portion of the extension portion on the base end side is increased. Accordingly, deformation of the extension portion may be prevented. Therefore, the collision load applied to the bumper reinforcement may be more appropriately transmitted to the crash box.

(6) The front structure of a vehicle according to (5), in which
the protruding portion protrudes rearward, and
the edge portion of the opening is sandwiched between the fitting portion and the protruding portion.

According to such a configuration, since the protruding portion protrudes rearward, the protruding portion may be formed without interfering with the bumper reinforcement.

Further, according to the above-described configuration, since the edge portion of the opening is sandwiched between the fitting portion and the protruding portion, relative displacement between the extension portion and the crash box is restricted. Accordingly, the rigidity of the extension portion may be increased, and the collision load applied to the bumper reinforcement may be more appropriately transmitted to the crash box.

According to the present disclosure, the joining between the front end of the crash box and the bumper reinforcement may be omitted, and a collision load applied to the bumper reinforcement may be appropriately transmitted to the crash box.

### BRIEF DESCRIPTION OF DRAWINGS

Exemplary embodiment(s) of the present invention will be described in detail based on the following figures, wherein:

FIG. 1 is an exploded perspective view illustrating a vehicle structure and a front structure of a vehicle according to an embodiment;

FIG. 2 is an enlarged rear view mainly illustrating an extension portion of the front structure in FIG. 1;

FIG. 3 is a cross-sectional view taken along a line 3-3 in FIG. 2; and

FIG. 4 is a cross-sectional view taken along a line 4-4 in FIG. 2.

### DESCRIPTION OF EMBODIMENTS

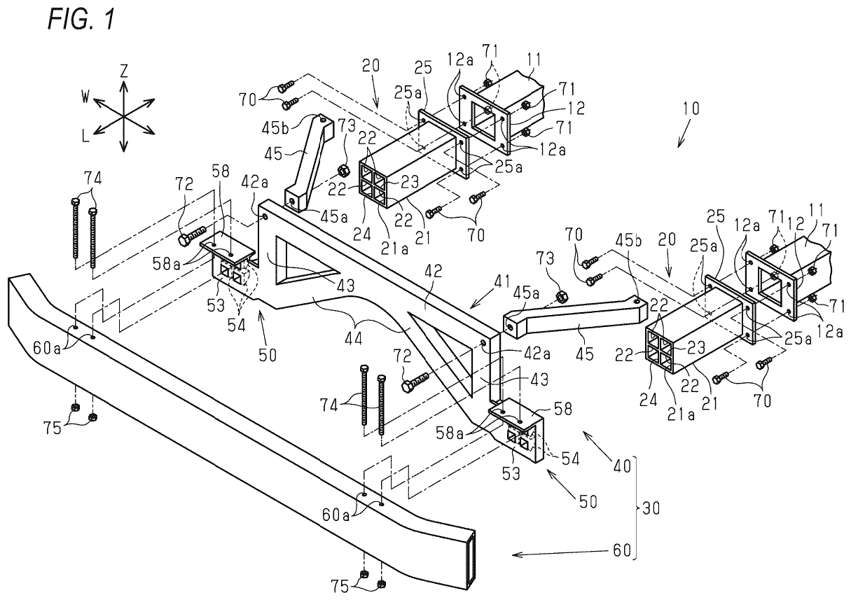

Hereinafter, an embodiment of a front structure of a vehicle will be described with reference to FIGS. 1 to 4.

As illustrated in FIG. 1, a vehicle structure 10 and a front structure 30 to be assembled to the vehicle structure 10 are provided at a front portion of the vehicle.

In the following description, a front-rear direction of the vehicle is referred to as a front-rear direction L, a vehicle width direction is referred to as a vehicle width direction W, and an upper-lower direction of the vehicle when the vehicle is located on a horizontal plane is referred to as an upper-lower direction Z. Further, the front and the rear in the front-rear direction L are simply referred to as “front” and “rear”, respectively.

A front portion of the vehicle according to the present embodiment has a symmetrical structure in the vehicle width direction W. Therefore, hereinafter, the left half of the front portion of the vehicle at the time when viewed from the front to the rear will be described, and a description for the right half may be omitted.

### Vehicle Structure 10

As illustrated in FIG. 1, the vehicle structure 10 includes a pair of front side members 11 disposed at an interval in the vehicle width direction W, and a pair of crash boxes 20 located in front of the pair of front side members 11 respectively.

The vehicle structure 10 is made of a metal.

### Front Side Member 11

The front side member 11 has a tubular shape extending in the front-rear direction L, and forms a part of a pair of vehicle body frames forming the vehicle structure 10 on both sides in the vehicle width direction W.

A side-member-side flange portion 12 having a rectangular annular shape in a front view, which protrudes outward in a radial direction of the front side member 11, is provided at a front end of the front side member 11.

A through hole 12a, which penetrates the side-member-side flange portion 12 in the front-rear direction L, is formed at each of four corner portions of the side-member-side flange portion 12.

### Crash Box 20

As illustrated in FIG. 1, the crash box 20 includes a tubular portion 21 extending in the front-rear direction L, and a crash box-side flange portion 25 protruding outward in a radial direction of the tubular portion 21 from a rear end of the tubular portion 21.

The tubular portion 21 has a center hole 21a.

Inside the center hole 21a, a plate-shaped first reinforcement portion 23 that divides the center hole 21a into two in the upper-lower direction Z and a plate-shaped second reinforcement portion 24 that intersects the first reinforcement portion 23 and divides the center hole 21a into two in the vehicle width direction W are provided. That is, the center hole 21a is divided into four through holes by the first reinforcement portion 23 and the second reinforcement portion 24. An opening portion of the center hole 21a is divided into four by a front end of the first reinforcement portion 23 and a front end of the second reinforcement portion 24, so that four openings 22 are formed at a front end of the tubular portion 21.

The crash box-side flange portion 25 has a rectangular annular shape in a rear view.

A through hole 25a, which penetrates the crash box-side flange portion 25 in the front-rear direction L, is formed at each of four corner portions of the crash box-side flange portion 25.

The crash box 20 is fixed to the front end of the front side member 11 by screwing nuts 71 to respective bolts 70 inserted through the through holes 12a and 25a.

### Front Structure 30

As illustrated in FIG. 1, the front structure 30 includes a support member 40 located between the pair of crash boxes 20, and a bumper reinforcement 60 located in front of the pair of crash boxes 20 and extending in the vehicle width direction W.

### Support Member 40

As illustrated in FIG. 1, the support member 40 includes a body portion 41 located between the pair of crash boxes 20, fixing portions 45 extending from the body portion 41, a pair of extension portions 50 extending from the body portion 41, and a pair of attachment portions 58.

### Body Portion 41

As illustrated in FIG. 1, the body portion 41 includes an upper wall portion 42 extending in the vehicle width direction W, a pair of side wall portions 43 extending downward from both ends in the vehicle width direction W of the upper wall portion 42, and a pair of inclined portions 44 extending from lower ends of the pair of side wall portions 43 toward a central portion of the upper wall portion 42.

A through hole 42a, which penetrates the upper wall portion 42 in the front-rear direction L, is formed at each of both ends in the vehicle width direction W of the upper wall portion 42.

The inclined portion 44 is inclined such that the closer a portion is to a center side of the upper wall portion 42 in the vehicle width direction W, the higher the position is.

### Fixing Portion 45

The fixing portion 45 is located behind the body portion 41, and is fixed to the body portion 41 and a portion (not illustrated), which is located above the front end of the front side member 11, of the pair of vehicle body frames forming the vehicle structure 10.

The fixing portion 45 includes a front end portion extending in the front-rear direction L, a central portion extending at an incline from a rear end of the front end portion such that the more outward a portion is located in the vehicle width direction W, the more rearward the portion is located, and a rear end portion extending in the front-rear direction L from a rear end of the central portion.

A first through hole 45a, which penetrates the front end portion of the fixing portion 45 in the front-rear direction L, is formed in the front end portion of the fixing portion 45. The fixing portion 45 is fixed to the upper wall portion 42 by screwing a nut 73 to a bolt 72 inserted through the through hole 42a and the first through hole 45a.

A second through hole 45b, which penetrates the rear end portion of the fixing portion 45 in the upper-lower direction Z, is formed in the rear end portion of the fixing portion 45. By inserting a bolt (not illustrated) into the second through hole 45b, the fixing portion 45 is fixed to the portion (not illustrated), which is located above the front end of the front side member 11, of the pair of vehicle body frames forming the vehicle structure 10.

### Extension Portion 50

As illustrated in FIG. 1, the extension portions 50 extend from the body portion 41 toward the front of the openings 22 of the pair of crash boxes 20, respectively.

The extension portion 50 includes a flat portion 53 extending outward in the vehicle width direction W from the lower end of the side wall portion 43, and fitting portions 54 protruding rearward from the flat portion 53.

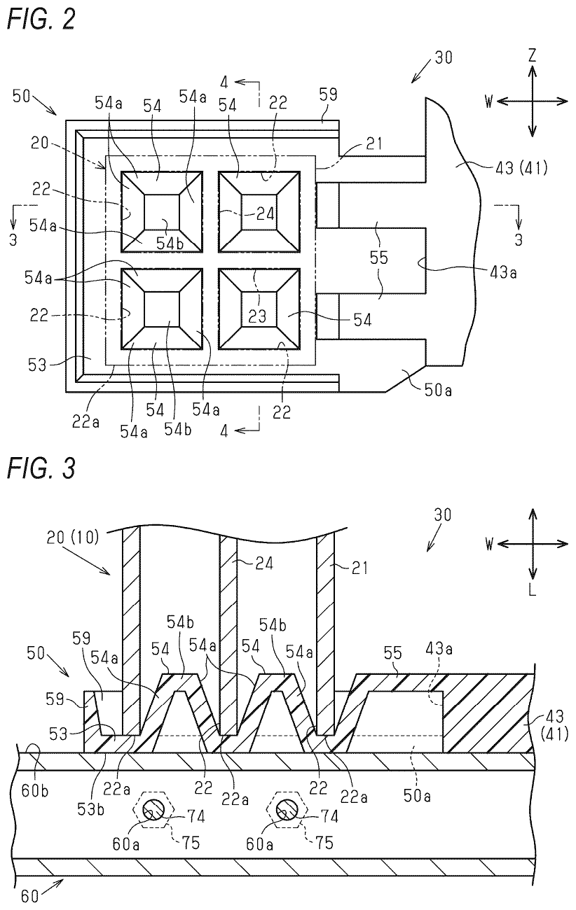

As illustrated in FIGS. 2 and 3, the flat portion 53 has a substantially rectangular plate shape in a front view.

A base end 50a of the flat portion 53 and the side wall portion 43 are connected via a step portion 43a.

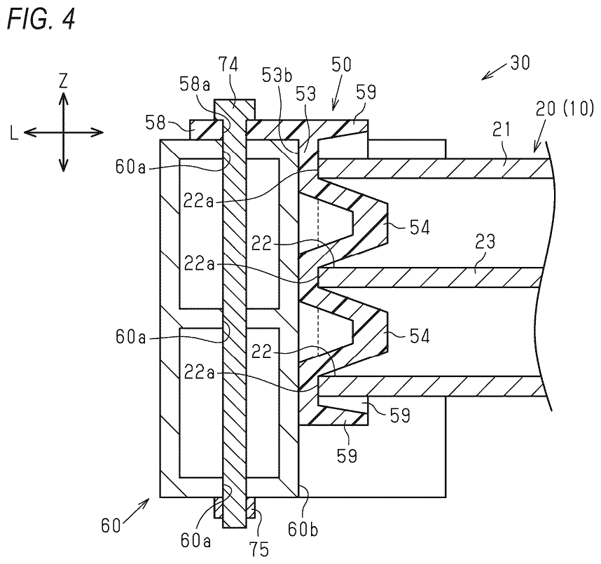

As illustrated in FIGS. 3 and 4, the flat portion 53 is in contact with an edge portion 22a of the openings 22 of the crash box 20. In the present embodiment, the flat portion 53 is in contact with an entire periphery of the edge portion 22a of the plurality of openings 22.

As illustrated in FIGS. 2 and 3, the base end 50a of the flat portion 53 has protruding portions 55 protruding rearward from the flat portion 53. The protruding portion 55 has a hollow shape extending in the vehicle width direction W and opening forward.

An inner end portion in the vehicle width direction W of the protruding portion 55 is connected to the step portion 43a.

An outer end portion in the vehicle width direction W of the protruding portion 55 is inclined such that the more outward a portion is located in the vehicle width direction W, the more forward the portion is located.

In the present embodiment, two protruding portions 55 are formed at an interval in the upper-lower direction Z.

The fitting portion 54 is formed at a position corresponding to the opening 22 of the crash box 20 and is fitted to the opening 22. In the present embodiment, the four fitting portions 54 are formed at positions corresponding to the four openings 22 and are fitted to the four openings 22, respectively. All of the fitting portions 54 are inserted into the center hole 21a.

The fitting portion 54 is located outside the protruding portion 55 in the vehicle width direction W.

In the present embodiment, the fitting portion 54 has a truncated quadrangular pyramid shape and a hollow shape that opens forward. In addition, the four fitting portions 54 have the same shape.

The fitting portion 54 includes four trapezoidal side walls 54a each of which protrudes rearward from the flat portion 53 and is inclined such that the more rearward a portion is located, the closer the portion is to a center side of the opening 22, and one rectangular top wall 54b connected to rear ends of the four side walls 54a.

A portion, which is formed of a peripheral wall of the tubular portion 21, of the edge portion 22a of the opening 22 is sandwiched between the fitting portion 54 and the protruding portion 55.

A portion, which is formed of an edge portion of the second reinforcement portion 24, of the edge portion 22a of the opening 22 is sandwiched between the two fitting portions 54 disposed adjacent to each other in the vehicle width direction W.

As illustrated in FIGS. 2 and 4, a portion, which is formed by an edge portion of the first reinforcement portion 23, of the edge portion 22a of the opening 22 is sandwiched between two fitting portions 54 disposed adjacent to each other in the upper-lower direction Z.

A protrusion 59 protruding rearward is formed on a peripheral edge of the flat portion 53. The protrusion 59 extends to surround the four fitting portions 54.

### Attachment Portion 58

As illustrated in FIGS. 1 and 4, the attachment portion 58 protrudes forward from an upper edge of the flat portion 53 and has a plate shape.

A plurality of through holes 58a, which penetrate the attachment portion 58 in the upper-lower direction Z, are formed on the attachment portion 58. In the present embodiment, two through holes 58a are formed at an interval in the vehicle width direction W.

The body portion 41, the pair of extension portions 50, and the pair of attachment portions 58 are made of a fiber reinforced resin. A reinforcing fiber contained in the fiber reinforced resin is, for example, a glass fiber.

The body portion 41, the pair of extension portions 50, and the pair of attachment portions 58 are integrally molded by injection molding.

### Bumper Reinforcement 60

As illustrated in FIGS. 1 and 4, the bumper reinforcement 60 has a tubular shape.

On the bumper reinforcement 60, through holes 60a, which penetrate the bumper reinforcement 60 in the upper-lower direction Z, are formed at positions corresponding to the through holes 58a of the attachment portion 58.

The bumper reinforcement 60 is fixed to the attachment portion 58 by screwing nuts 75 to respective bolts 74 inserted through the through holes 58a and 60a.

As illustrated in FIGS. 3 and 4, a rear surface 60b of the bumper reinforcement 60 is in contact with a front surface 53b of the flat portion 53 and sandwiches the flat portion 53 between the rear surface 60b and the edge portion 22a of the openings 22 of the crash box 20. In the present embodiment, the flat portion 53 is sandwiched between the rear surface 60b of the bumper reinforcement 60 and the entire periphery of the edge portion 22a of the plurality of openings 22. The rear surface 60b of the bumper reinforcement 60 is in contact with the entire front surface 53b of the flat portion 53.

### Operations of Present Embodiment

As illustrated in FIG. 1, the front structure 30 including the support member 40 and the bumper reinforcement 60 is formed by attaching the attachment portions 58 of the support member 40 to the bumper reinforcement 60. As illustrated in FIGS. 3 and 4, when the front structure 30 is attached to the vehicle structure 10, the plurality of fitting portions 54 of the pair of extension portions 50 are respectively fitted into the plurality of openings 22 of the pair of crash boxes 20. As illustrated in FIG. 1, the front structure 30 is fixed to the vehicle structure 10 by fixing the fixing portions 45 of the support member 40 to the respective portions (not illustrated) of the vehicle body frames. Accordingly, relative displacement of the support member 40 with respect to the pair of crash boxes 20, that is, relative displacement of the bumper reinforcement 60 is restricted.

### Effects of Present Embodiment

(1) The support member 40 includes the body portion 41 located between the pair of crash boxes 20, the attachment portions 58 attached to the bumper reinforcement 60, and the fixing portions 45 extending from the body portion 41 and fixed to the respective portions (not illustrated) of the vehicle body frames. The support member 40 further includes the pair of extension portions 50 extending from the body portion 41 toward the front of the openings 22 of the pair of crash boxes 20, respectively. The extension portion 50 includes the fitting portions 54 protruding rearward from the flat portion 53 and fitted to the respective openings 22.

According to such a configuration, since the above-described operation is implemented, the joining between a front end of the crash box 20 and the bumper reinforcement 60 may be omitted, and a collision load applied to the bumper reinforcement 60 may be appropriately transmitted to the crash box 20.

(2) The plurality of openings 22 are formed at the front end of the crash box 20. The extension portion 50 includes the plurality of fitting portions 54 that are respectively fitted into the plurality of openings 22.

According to such a configuration, relative movement between the crash box 20 and the bumper reinforcement 60 is restricted at a plurality of locations at the front end of the crash box 20. Accordingly, the collision load applied to the bumper reinforcement 60 may be more appropriately transmitted to the crash box 20.

(3) The extension portion 50 includes a flat portion 53 sandwiched between the edge portion 22a of the openings 22 and the bumper reinforcement 60.

According to such a configuration, the rear surface 60b of the bumper reinforcement 60 and the flat portion 53 of the extension portion 50 are in surface contact with each other, and the edge portion 22a of the openings 22 of the crash box 20 and the flat portion 53 of the extension portion 50 are in surface contact with each other. Accordingly, the collision load applied to the bumper reinforcement 60 may be more appropriately transmitted to the crash box 20.

(4) The flat portion 53 is provided over an entire periphery of the openings 22.

According to such a configuration, when the collision load is applied to the bumper reinforcement 60, the entire edge portion 22a of the openings 22 is pressed by the flat portion 53. Therefore, the collision load transmitted from the bumper reinforcement 60 may be prevented from being biased depending on a position of the front end of the crash box 20. Therefore, the collision load applied to the bumper reinforcement 60 may be more appropriately transmitted to the crash box 20.

(5) The extension portion 50 has the protruding portions 55 protruding rearward on a base end 50a side of the extension portion 50 with respect to the fitting portions 54.

When the collision load acts on the extension portion 50 via the bumper reinforcement 60, stress tends to concentrate on a portion of the extension portion 50 on the base end 50a side.

In this regard, according to the above-described configuration, since the portion of the extension portion 50 on the base end 50a side has the protruding portions 55, the rigidity of the portion of the extension portion 50 on the base end 50a side is increased. Accordingly, deformation of the extension portion 50 may be prevented. Therefore, the collision load applied to the bumper reinforcement 60 may be more appropriately transmitted to the crash box 20.

(6) The edge portion 22a of the openings 22 is sandwiched between the fitting portions 54 and the protruding portions 55.

According to such a configuration, since the protruding portion 55 protrudes rearward, the protruding portion 55 may be formed without interfering with the bumper reinforcement 60.

Further, according to the above-described configuration, since the edge portion 22a of the openings 22 is sandwiched between the fitting portions 54 and the protruding portions 55, relative displacement between the extension portion 50 and the crash box 20 is restricted. Accordingly, the rigidity of the extension portion 50 may be increased, and the collision load applied to the bumper reinforcement 60 may be more appropriately transmitted to the crash box 20.

### Modifications

The present embodiment may be modified and implemented as follows. The present embodiment and the following modifications may be combined with each other and implemented without technical contradiction.

In the above-described embodiment, the portion of the extension portion 50 on the base end 50a side of the extension portion 50 with respect to the fitting portions 54 has two protruding portions 55, but the number of protruding portions 55 may be one or three or more.

The edge portion 22a of the openings 22 may be sandwiched between the fitting portions 54 and the protrusion 59 by adjusting a position of the protrusion 59 or an inclination with respect to the front-rear direction L.

In the above-described embodiment, the pair of extension portions 50, the pair of attachment portions 58, and the body portion 41 are made of the fiber reinforced resin, but the pair of extension portions 50, the pair of attachment portions 58, and the body portion 41 may be made of a metal.

In the above-described embodiment, the edge portion 22a of the openings 22 is sandwiched between the fitting portions 54 and the protruding portions 55, but an outer end portion in the vehicle width direction W of the protruding portion 55 may not be adjacent to the edge portion 22a of the openings 22.

The plurality of fitting portions 54 may have different shapes.

In the above-described embodiment, the protruding portion 55 protrudes rearward, but the protruding portion 55 may protrude forward as long as there is no interference with the bumper reinforcement 60.

The protruding portion 55 may be omitted as long as the extension portion 50 is less likely to be deformed by a collision load acting on the base end 50a of the extension portion 50.

In the above-described embodiment, the flat portion 53 is sandwiched between the edge portion 22a and the bumper reinforcement 60 over the entire periphery of the openings 22, but the present disclosure is not limited thereto. The flat portion 53 may be sandwiched only between a part of the edge portion 22a of the openings 22 and the bumper reinforcement 60.

As long as the fitting portion 54 is fitted to the opening 22 of the crash box 20, a gap may be formed between the edge portion 22a of the opening 22 and the flat portion 53 in the front-rear direction L in a state in which the edge portion 22a of the opening 22 and the side wall 54a of the fitting portion 54 are in contact with each other.

In the above-described embodiment, the four openings 22 are formed at the front end of the crash box 20, but the number of the openings 22 may be one, two, three, or five or more. At this time, the number of the fitting portions 54 is sufficiently at least one, and may be the same as the number of the openings 22, or may be smaller than the number of the openings 22.

In the above-described embodiment, the attachment portion 58 is provided on the extension portion 50, but the attachment portion 58 may be provided on the body portion 41.

In the above-described embodiment, the pair of extension portions 50, the pair of attachment portions 58, and the body portion 41 are integrally molded by injection molding, but the pair of extension portions 50, the pair of attachment portions 58, and the body portion 41 may be formed as separate bodies.

The opening 22 may be formed at the front end of the crash box 20 by forming a hole that opens forward at the front end of the crash box 20.

What is claimed is:

1. A front structure of a vehicle to be applied to a vehicle structure and to be assembled to the vehicle structure, the vehicle structure including a pair of vehicle body frames disposed at an interval in a vehicle width direction and a pair of crash boxes located in front of the pair of vehicle body frames in a front-rear direction of the vehicle and attached to the pair of vehicle body frames respectively, the pair of crash boxes having an opening being formed at a front end of the pair of crash boxes, the front structure comprising:
a support member located between the pair of crash boxes; and
a bumper reinforcement located in front of the pair of crash boxes and extending in the vehicle width direction, when a front and rear in the front-rear direction of the vehicle are defined as the front and rear, wherein
the support member includes:
a body portion located between the pair of crash boxes;
an attachment portion attached to the bumper reinforcement;
a fixing portion extending from the body portion and fixed to the vehicle body frame; and
a pair of extension portions extending from the body portion toward the front of the opening of the pair of crash boxes respectively, and
each of the pair of extension portions has a fitting portion protruding rearward and fitted into the opening.

2. The front structure of a vehicle according to claim 1, wherein
a plurality of openings are formed at the front end of the pair of crash box, and
the pair of extension portions include a plurality of fitting portions fitted to the plurality of openings respectively.

3. The front structure of a vehicle according to claim 1, wherein
the extension portion includes a flat portion sandwiched between an edge portion of the opening and the bumper reinforcement.

4. The front structure of a vehicle according to claim 3, wherein
the flat portion is provided over an entire periphery of the opening.

5. The front structure of a vehicle according to claim 3, wherein
the extension portion includes a protruding portion protruding forward or rearward on a base end side of the extension portion with respect to the fitting portions.

6. The front structure of a vehicle according to claim 5, wherein
the protruding portion protrudes rearward, and
the edge portion of the opening is sandwiched between the fitting portion and the protruding portion.
